(19) United States
(12) Patent Application Publication
(10) Pub. No.: US 2004/0179676 A1
(43) Pub. Date: Sep. 16, 2004

(54) Speech communication apparatus

(76) Inventors: Kozo Okuda, Hirakata City (JP); Mitsuo Fujimoto, Sakurai City (JP); Takeo Inoue, Hirakata City (JP); Mika Kirimoto, Higashiosaka City (JP); Naoya Iwasaki, Hirakata City (JP)

Correspondence Address: SMITH, GAMBRELL & RUSSELL, LLP, 1850 M STREET, N.W., SUITE 800, WASHINGTON, DC, 20036, US

(21) Appl. No.: 10/810,852

(22) Filed: Mar. 29, 2004

Related U.S. Application Data
(63) Continuation of application No. 09/605,415, filed on Jun. 28, 2000, now abandoned.

(30) Foreign Application Priority Data
Jun. 30, 1999 (JP) 11-186031
Aug. 3, 1999 (JP) 11-219952

(51) Int. Cl. H04M 1/00; H04M 9/08

(52) U.S. Cl. 379/399.01; 379/387.01; 379/406.01

(57) ABSTRACT

A speech communication apparatus comprises voice speed conversion means for changing the time scale of a voice signal of a called party which arrives through a telephone line, and sidetone erasure means for erasing a sidetone signal.

### BACKGROUND OF THE INVENTION

1. Field of the Invention

The present invention relates generally to a speech communication apparatus which is represented by a telephone set, and more particularly, to a telephone set comprising a voice speed conversion function.

2. Description of the Prior Art

Conventionally known as an example of a telephone set comprising a voice speed conversion function is one disclosed in JP-A-6-311211. A telephone set disclosed in this gazette is so constructed that it is possible to select a “slow listening” mode by operating a mode key, expand the time scale of a voice signal from a called party by a voice speed conversion processing circuit while the mode is being selected, and catch words of the called party in a slow voice.

Voice speed conversion thus means that the time scale of the voice signal is compressed to make its reproduction speed (voice speed) higher than its original speed, while being conversely expanded to make the reproduction speed (voice speed) lower than the original speed.

In the conventional telephone set, a sidetone which has been subjected to voice speed conversion can be heard in a telephone receiver on the side of a calling party. Accordingly, it is significantly difficult for the calling party to speak.

FIG. 1 illustrates the configuration of a conventional telephone set comprising a voice speed conversion function.

A voice signal of a calling party which is inputted from a microphone 1 is outputted to a telephone line through a two-wire/four-wire converting circuit 3. Each of a microphone and a loudspeaker is composed of respective two wires on the plus and minus sides, that is, a total of four wires. Further, the telephone line is composed of two lines. In FIG. 1, only a signal line is described, so that each of the microphone and the loudspeaker is composed of one wire, and the telephone line is composed of one wire.

In such a telephone set, impedance mismatching between the telephone line and the telephone set itself occurs. Accordingly, the voice signal of the calling party is reflected on the two-wire/four-wire converting circuit 3, and is inputted to the voice speed converting circuit 4 upon being mixed (overlapped) with a telephone receiving signal. The voice signal which has been inputted upon being reflected (a sidetone signal) is converted into a slow voice signal in the voice speed converting circuit 4, and the slow voice signal is outputted from a loudspeaker 2 in a telephone receiver on the side of the calling party. Consequently, the voice of the calling party can be heard by the calling party as a sidetone which has been subjected to voice speed conversion. Accordingly, it is significantly difficult for the calling party to speak.

When called party's talk is received by the telephone set comprising the voice speed converting circuit 4, the voice signal from the called party is converted into a slow voice signal in the voice speed converting circuit 4, and the slow voice signal is outputted from a loudspeaker 2 in a telephone receiver on the side of the calling party, as shown in FIG. 2, so that the voice signal is easy to hear. In this case, no problem particularly occurs.

In the case of a hands-free telephone set, a television conference system, or the like, an echo problem further occurs in addition to the above-mentioned sidetone. That is, a voice on the side of voice signal transmission (a calling party) which has been outputted by a loudspeaker on the side of voice signal receiving (a called party) is returned as an echo to the calling party through a microphone on the side of the called party.

### SUMMARY OF THE INVENTION

A first speech communication apparatus according to the present invention is characterized by comprising a voice input device for inputting the voice of a calling party; a voice output device for outputting the voice of a called party; signal input/output means for introducing a voice signal of the calling party which has been outputted from the voice input device to a telephone line as well as receiving a voice signal of the called party which arrives through the telephone line; voice speed conversion means provided between the voice output device and the signal input/output means for changing the time scale of the voice signal of the called party which arrives through the telephone line and the signal input/output means; and sidetone erasure means provided between the voice speed conversion means and the signal input/output means for erasing a sidetone signal.

An example of the voice speed conversion means is one for changing the time scale of the voice signal of the called party which is inputted through the sidetone erasure means. An example of the voice speed conversion means is one for expanding the time scale of the voice signal of the called party which is inputted through the sidetone erasure means.

An example of the sidetone erasure means is one comprising means for referring to the voice signal of the calling party which has been outputted from the voice input device to generate a pseudo sidetone signal, and means for erasing, from a mixture of the voice signal of the called party which arrives through the telephone line and a sidetone signal, the sidetone signal using the pseudo sidetone signal.

A second speech communication apparatus according to the present invention is characterized by comprising a voice input device for inputting the voice of a calling party; a voice output device for outputting the voice of a called party; signal input/output means for introducing a voice signal of the calling party which has been outputted from the voice input device to a telephone line as well as receiving a voice signal of the called party which arrives through the telephone line; voice speed conversion means provided between the voice output device and the signal input/output means for changing the time scale of the voice signal of the called party which arrives through the telephone line; sidetone erasure means provided between the voice speed conversion means and the signal input/output means for erasing a sidetone signal; and means for mixing the voice signal of the calling party which has been outputted from the voice input device with a signal outputted by the voice speed conversion means and introducing a mixture of the signals to the voice output device.

An example of the sidetone erasure means is one comprising means for referring to the voice signal of the calling party which has been outputted from the voice input device to generate a pseudo sidetone signal, and means for erasing, from a mixture of the voice signal of the called party which arrives through the telephone line and a sidetone signal, the sidetone signal using the pseudo sidetone signal.

An example of the voice speed conversion means is one for changing the time scale of the voice signal of the called party which is inputted through the sidetone erasure means. An example of the voice speed conversion means is one for expanding the time scale of the voice signal of the called party which is inputted through the sidetone erasure means.

In a speech communication apparatus comprising an echo canceller for learning an echo path and optimizing a filter coefficient of an adaptive filter to remove an echo signal and output a telephone receiving signal, and voice speed conversion means for subjecting the telephone receiving signal outputted by the echo canceller to voice speed conversion, a third speech communication apparatus according to the present invention is characterized in that a voice speed-converting operation by the voice speed conversion means is stopped during a predetermined time period.

Examples of the predetermined time period include a time period during which an echo path is learned in the echo canceller, and an initial time period during which speech communication is started.

In a speech communication apparatus comprising an echo canceller receiving a telephone transmitting signal as a reference input signal, generating a pseudo echo signal on the basis of the reference input signal, removing an echo signal which arrives by the pseudo echo signal, and outputting a telephone receiving signal, and voice speed conversion means for subjecting the telephone receiving signal inputted through the echo canceller to voice speed conversion and outputting the telephone receiving signal which has been subjected to voice speed conversion, a fourth speech communication apparatus according to the present invention is characterized in that a voice speed converting operation by the voice speed conversion means is stopped during a predetermined time period.

Examples of the predetermined time period include a time period during which an echo path is learned in the echo canceller, and an initial time period during which speech communication is started.

In a speech communication apparatus comprising an echo canceller for learning an echo path and optimizing a filter coefficient of an adaptive filter to remove an echo signal and output a telephone receiving signal, and voice speed conversion means for subjecting the telephone receiving signal outputted by the echo canceller to voice speed conversion, a fifth speech communication apparatus according to the present invention is characterized by comprising means for judging whether or not the echo signal which cannot be removed by the echo canceller (a removal error signal) is at not less than a predetermined level; and means for stopping a voice speed converting operation by the voice speed conversion means when the echo signal which cannot be removed by the echo canceller (the removal error signal) is at not less than the predetermined level.

In a speech communication apparatus comprising an echo canceller receiving a telephone transmitting signal as a reference input signal, generating a pseudo echo signal on the basis of the reference input signal, removing an echo signal which arrives by the pseudo echo signal, and outputting a telephone receiving signal, and voice speed conversion means for subjecting the telephone receiving signal inputted through the echo canceller to voice speed conversion and outputting the telephone receiving signal which has been subjected to voice speed conversion, a sixth speech communication apparatus according to the present invention is characterized by comprising means for judging whether or not the echo signal which cannot be removed by the echo canceller (a removal error signal) is at not less than a predetermined level; and means for stopping a voice speed converting operation by the voice speed conversion means when the echo signal which cannot be removed by the echo canceller (the removal error signal) is at not less than the predetermined level.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for explaining the operation of a conventional telephone set;

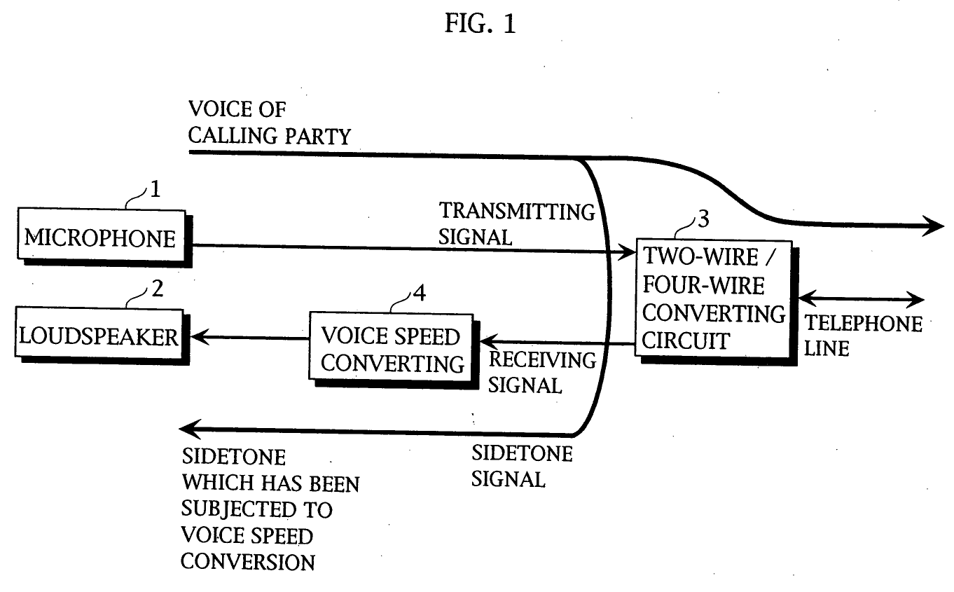

FIG. 2 is a diagram for explaining the operation of the conventional telephone set:

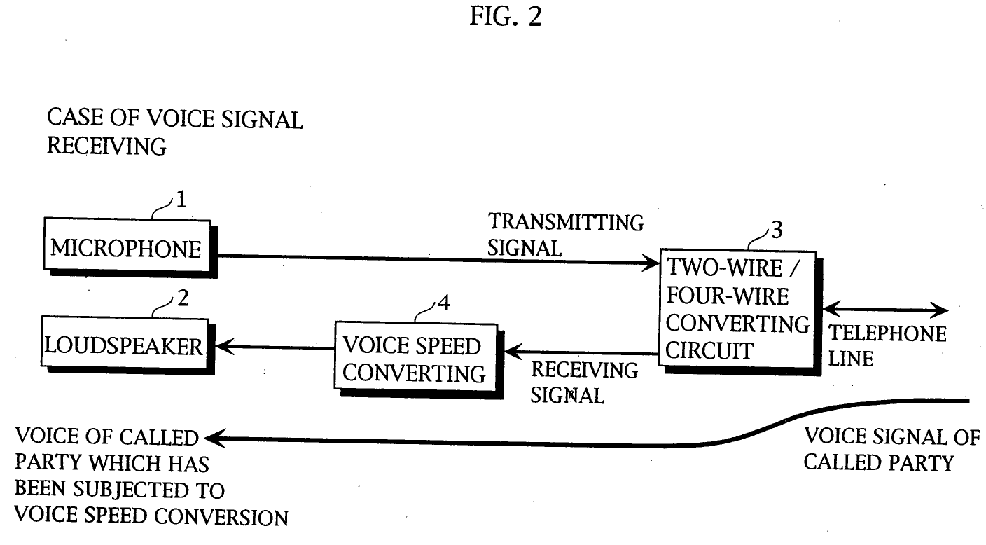

FIG. 3 is a block diagram showing the configuration of a telephone set according to a first embodiment of the present invention;

FIG. 4 is a block diagram mainly showing the functions of an echo canceller and a voice speed converting unit;

FIG. 5 is a diagram for explaining the operation of the telephone set shown in FIG. 3;

FIG. 6 is a diagram for explaining the operation of the telephone set shown in FIG. 3;

FIG. 7 is a schematic block diagram showing the configuration of a telephone set according to a second embodiment; and

FIG. 8 is a block diagram showing the configuration of an echo canceller provided in a telephone set according to a third embodiment.

### DESCRIPTION OF THE PREFERRED EMBODIMENTS

### [1] Description of First Embodiment

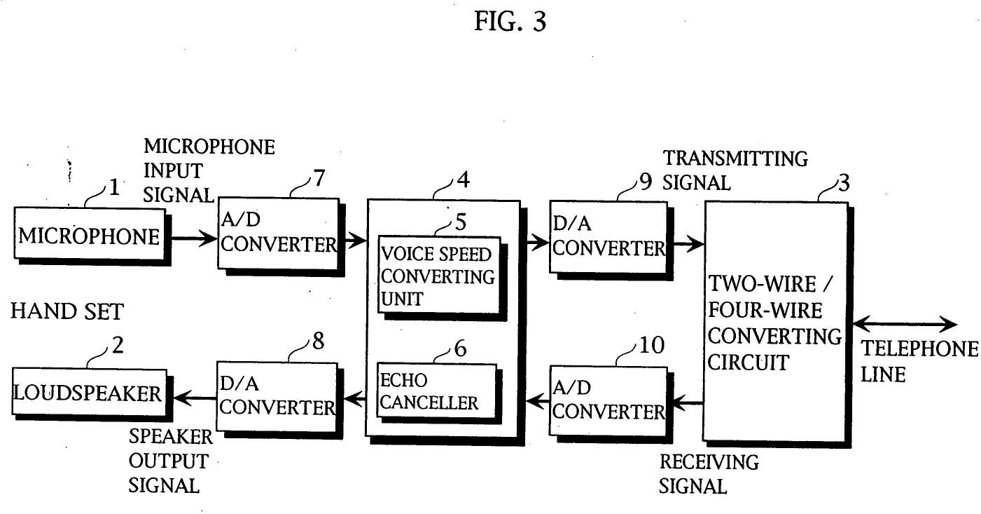

FIG. 3 illustrates the configuration of a telephone set comprising a voice speed converter.

In FIG. 3, reference numeral 1 denotes a microphone provided in a hand set, and reference numeral 2 denotes a loudspeaker provided in the hand set. Reference numeral 4 denotes a microcomputer (a control unit) for controlling the whole of the telephone set, which comprises a voice speed converting unit 5 and an echo canceller (sidetone erasure means) 6. The microcomputer 4 may be replaced with a DSP (Digital Signal Processor).

Reference numeral 3 denotes a two-wire/four-wire converting circuit (input/output means). The telephone set is connected to a telephone line through the two-wire/four-wire converting circuit 3. Reference numerals 7 and 10 denote A/D (Analog-to-Digital) converters, and reference numerals 8 and 9 denote D/A (Digital-to-Analog) converters.

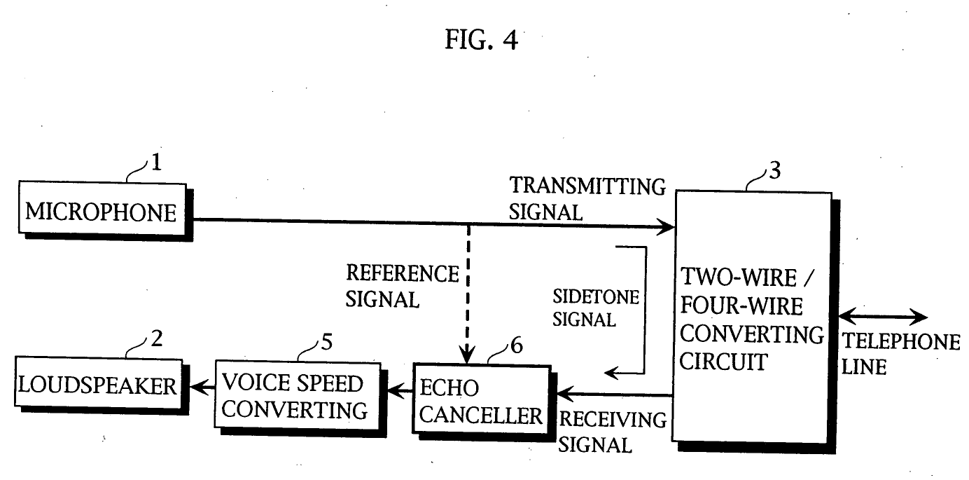

FIG. 4 shows the flow of a telephone transmitting signal and a telephone receiving signal. In FIG. 4, the A/D converters 7 and 10 and the D/A converters 8 and 9 are omitted.

The echo canceller 6 takes a voice signal of a calling party (a telephone transmitting signal) which is inputted from the microphone 1 as a reference signal, to generate a pseudo sidetone signal on the basis of the reference signal, as shown in FIG. 4. The echo canceller 6 subtracts the pseudo sidetone signal from a mixture of a sidetone signal and a voice signal of a called party (a telephone receiving signal) (the telephone receiving signal+the sidetone signal−the pseudo sidetone signal≈the telephone receiving signal), to erase the sidetone signal and take out only the telephone receiving signal. The sidetone signal is obtained by reflecting the voice signal of the calling party on the two-wire/four-wire converting circuit 3. Consequently, the echo canceller 6 generates the pseudo sidetone signal which almost coincides with the sidetone signal.

Such an echo canceller is a technique conventionally well-known. Therefore, the description of the detailed configuration of the echo canceller 6 is omitted.

The echo canceller 6 is not limited to one capable of completely erasing the sidetone signal. It can be considered that the sidetone signal is substantially erased, provided that the level thereof can be reduced to sucha degree that it does not prevent speech communication of a user (to such a degree that the sidetone signal can be hardly heard at the time of the speech communication). Consequently, “sidetone erasure means” used in the claims is not limited to means for erasing the sidetone. For example, it also includes means for reducing the sidetone.

The telephone line is not limited to one by wire. For example, it may be by radio (micro waves) as in a portable telephone set.

The voice speed converting unit 5 comprises a time scale expanding portion (not shown) for expanding the time scale of the voice signal of the called party which arrives through the telephone line. As examples of a time scale expanding method used in the time scale expanding portion, it is possible to utilize the existing methods such as PICOLA (Pointer Interval Control Overlap and Add) by controlling the amount of movement of a pointer and TDHS (Time Domain Harmonic Scaling). However, the method of slowing the voice speed is not limited to the above-mentioned method. In short, any method may be used, provided that the time scale of a voice signal can be expanded to reduce its voice speed.

For example, the voice speed converting unit 5 may be of such simple construction that the voice of the called party is temporarily stored in the semiconductor memory, and is read out at a desired speed, to output a voice signal which has been subjected to voice speed conversion.

In the telephone set, the echo canceller 6 is provided in the preceding stage of the voice speed converting unit 5, as shown in FIG. 4, in order to prevent the voice of the calling party which has been inputted from the microphone 1 from being subjected to voice speed conversion and outputted from the loudspeaker 2.

As shown in FIG. 4, the voice signal which has been inputted from the microphone 1 is inputted to the echo canceller 6 through a path indicated by a broken line as a reference signal. Further, a mixture of the sidetone signal which is returned upon being reflected on the two-wire/four-wire converting circuit 3 and the telephone receiving signal from the called party is inputted as an input signal to the echo canceller 6. The echo canceller 6 detects and erases the sidetone signal from the input signal by referring to the reference signal, and transmits only the telephone receiving signal to the voice speed converting unit 5 in the succeeding stage. The erasure of the sidetone signal includes reduction of the sidetone to such a degree that there is practically no problem (the sidetone signal can be hardly heard by the user), and is not necessarily limited to erasure of 100% of the sidetone.

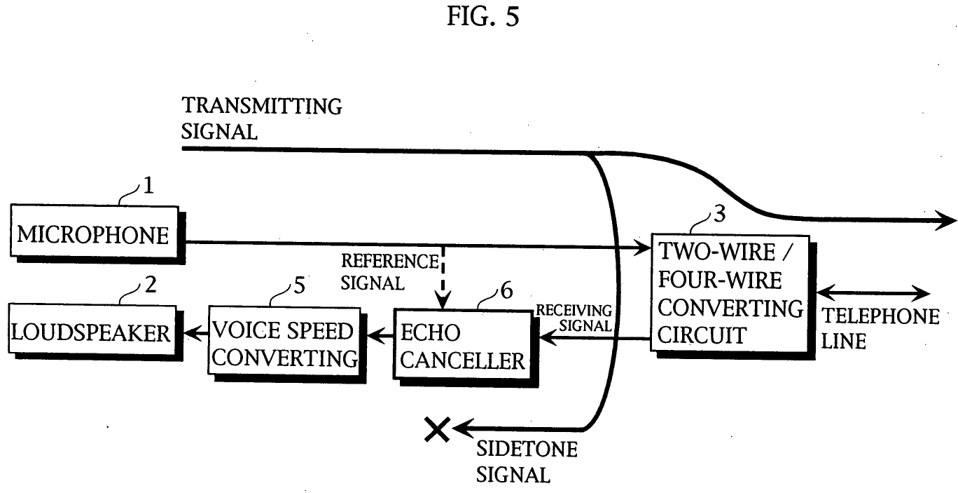

FIG. 5 shows the flow of a signal in the case of voice signal transmission. Also in FIG. 5, the A/D converters 7 and 10 and the D/A converters 8 and 9 are omitted.

The voice signal of the calling party which has been inputted from the microphone 1 is sent out to the telephone line through the two-wire/four-wire converting circuit 3. On the other hand, the sidetone signal which is returned upon being reflected on the two-wire/four-wire converting circuit 3 is detected and removed by the echo canceller 6, so that the sidetone signal is not heard from the loudspeaker 2 through the voice speed converting unit 5.

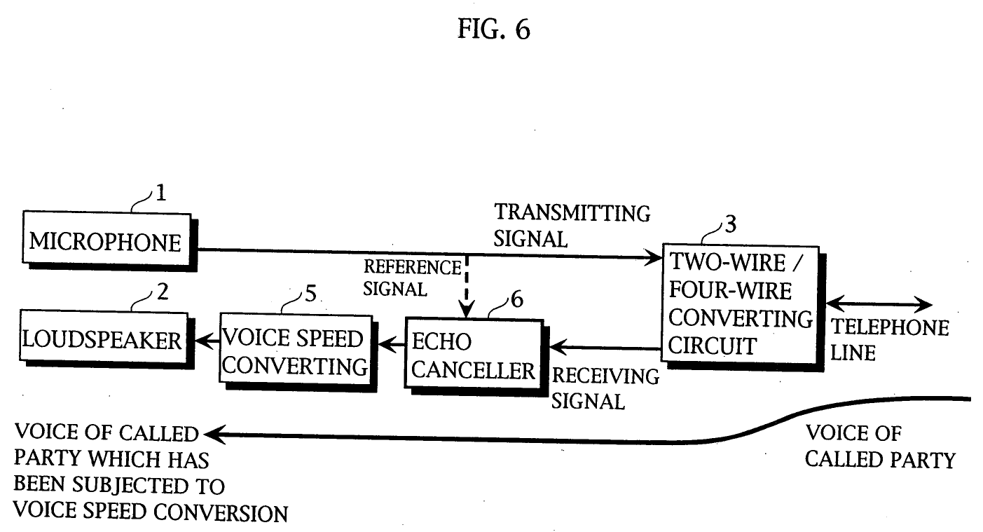

FIG. 6 shows the flow of a signal in the case of voice signal receiving. Also in FIG. 6, the A/D converters 7 and 10 and the D/A converters 8 and 9 are omitted.

The telephone receiving signal of the called party which arrives through the telephone line is fed to the voice speed converting unit 5 through the echo canceller 6. In the voice speed converting unit 5, the telephone receiving signal is subjected to time scale expansion processing. Accordingly, the telephone receiving signal which has been inputted to the voice speed converting unit 5 is converted into a slow voice signal which is easy to hear, and the slow voice signal is then fed to the loudspeaker 2 and outputted therefrom.

According to the first embodiment, the sidetone is removed by the echo canceller 6 provided in the preceding stage of the voice speed converting unit 5, not to arrive at the voice speed converting unit 5. Accordingly, it is possible to avoid such a problem that the calling party does not easily speak by the sidetone which has been subjected to voice speed conversion.

### [2] Description of Second Embodiment

In the first embodiment, the sidetone is removed. Accordingly, a person who is accustomed to an apparatus which does not produces a sidetone, for example, a portable telephone set, does not have an uncomfortable feeling. In the case of a general wire telephone set, however, a sidetone is produced. Accordingly, a person who is accustomed to such a telephone set may, in some cases, have an uncomfortable feeling.

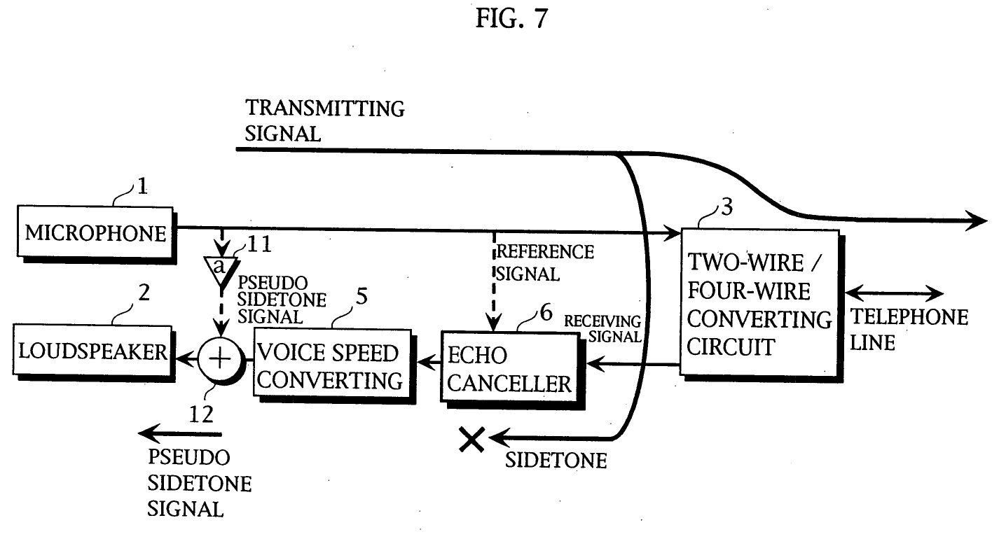

FIG. 7 illustrates the configuration of a telephone set in which such a problem is solved.

In the telephone set, a pseudo sidetone signal is generated by multiplexing a voice signal which has been inputted from a microphone 1 by a multiplier a using a multiplier 11, that is, adjusting the level of a voice signal which has been inputted from the microphone 1. By an adder 12 provided in the succeeding stage of the voice speed converting unit 5, the pseudo sidetone signal is mixed with a voice signal outputted from the voice speed converting unit 5. At the time of voice signal transmission, therefore, a voice signal of a calling party can be heard as a sidetone from a loudspeaker 2 without being subjected to voice speed conversion. Accordingly, the calling party can speak without having an uncomfortable feeling.

According to the second embodiment, the voice signal of the calling party which has been inputted from the microphone 1 is mixed as a pseudo sidetone signal with an output of the voice speed converting unit 5. Accordingly, the voice of the calling party which has not been subjected to voice speed conversion at the time of voice signal transmission can be heard as a pseudo sidetone from the loudspeaker 2.

### [3] Description of Third Embodiment

The overall configuration of a telephone set is the same as that shown in FIG. 3 and hence, the description thereof is not repeated. The third embodiment is characterized by the configuration of an echo canceller 6.

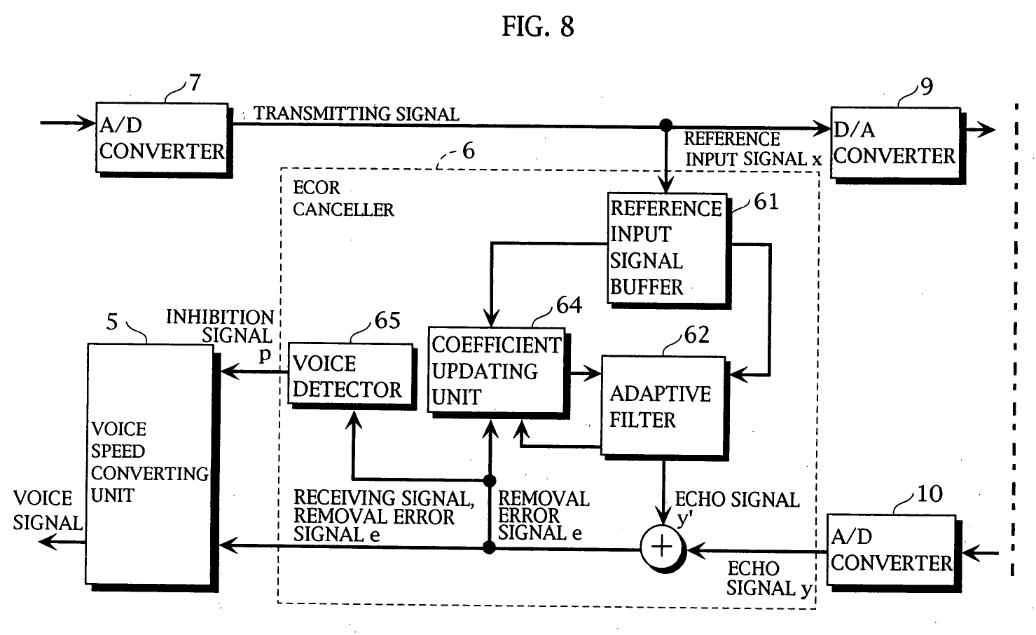

FIG. 8 illustrates the configuration of the echo canceller 6.

Reference numeral 61 denotes a reference input signal buffer for inputting a voice signal of a calling party (a telephone transmitting signal) which has been inputted from a microphone 1 as a reference input signal x, reference numeral 62 denotes an adaptive filter, and reference numeral 64 denotes a coefficient updating unit for optimizing a filter coefficient of the adaptive filter 62 by learning to reduce an echo and a sidetone more satisfactorily.

The reference input signal x stored in the reference input signal buffer 61 is fed to the coefficient updating unit 64 and the adaptive filter 62 at predetermined timing. The adaptive filter 62 generates a pseudo echo signal y′ on the basis of the reference input signal fed from the reference input signal buffer 61 and the coefficient obtained by the coefficient updating unit 64.

A large part of an echo signal y (a signal including a sidetone and an echo) which arrives through an A/D converter 10 is removed by the difference between the echo signal and the pseudo echo signal y′ (≈y) generated by the adaptive filter 62. However, the echo signal which cannot be removed is outputted as a removal error signal e.

The removal error signal e is fed to the coefficient updating unit 64 and a voice speed converting unit 5 in the succeeding stage. The coefficient updating unit 64 learns such a filter coefficient of the adaptive filter 62 that the removal error signal e is the minimum, to update the filter coefficient to the most suitable value. Consequently, the echo signal can be efficiently removed.

During a learning period in the coefficient updating unit 64, the filter coefficient of the adaptive filter 62 is not optimized. The echo signal which cannot be removed (a removal error signal e) is subjected to voice speed conversion in the voice speed converting unit 5 in the succeeding stage, and is further outputted from the loudspeaker 2 through a D/A converter 8 and heard.

In order to solve this problem, in the third embodiment, a voice detector 65 for detecting the level of the removal error signal e is provided, as shown in FIG. 8. While the voice detector 65 is detecting the removal error signal e whose level is not less than a predetermined level, an inhibition signal p for stopping a voice speed converting operation is outputted to the voice speed converting unit 5.

The voice speed converting unit 5 stops voice speed conversion processing while it is receiving the inhibition signal p, to output a voice signal which has not been subjected to voice speed conversion to the D/A converter 8 in the succeeding stage.

The voice detector 65 may detect the signal level of the removal error signal e by using an adaptive threshold following the level of background noises, for example.

Furthermore, the echo canceller 6 is not limited to one capable of completely removing the echo signal. It can be considered that the echo signal has been substantially removed, provided that the level thereof can be reduced to such a degree that it does not prevent speech communication of a user (to such a degree that the echo signal can be hardly heard at the time of the speech communication). Consequently, “echo signal removal means” in the claims is not limited to means for completely removing the echo signal. For example, it also includes means for reducing the echo signal.

The telephone line is not limited to one by wire. For example, it may be by radio (micro waves) as in a portable telephone set.

The operation of the telephone set according to the third embodiment will be described.

When a user first lifts a hand set to bring the telephone set to an off-hook state in order to start speech communication, the echo canceller 6 outputs an inhibition signal p to the voice speed converting unit 5. The inhibition signal p is outputted from the voice detector 65 inside the echo canceller 6. The echo canceller 6 outputs the inhibition signal p to the voice speed converting unit 5 irrespective of the presence or absence of a removal error signal e at the beginning of the speech communication.

The voice speed converting unit 5 stops voice speed conversion processing while it is receiving the inhibition signal p, and outputs a telephone receiving signal or the like which is inputted through the echo canceller 6 to the D/A converter 8 in the succeeding stage without subjecting the telephone receiving signal to voice speed conversion processing.

Thereafter, when a telephone is connected to a called party by a dialing operation to start conversation, the echo canceller 6 optimizes a filter coefficient of the adaptive filter 62 by learning an echo path. The echo canceller 6 takes a telephone transmitting signal from the microphone 1 as a reference input signal x, and generates a pseudo echo signal y′ on the basis of the reference input signal x. However, the filter coefficient of the adaptive filter 62 is not optimized immediately after the speech communication is started. Accordingly, the removal error signal e at not less than a predetermined level is outputted. Therefore, the coefficient updating unit 64 learns the echo path, to optimize the filter coefficient of the adaptive filter 62 such that the removal error signal e is the minimum.

When the optimization of the filter coefficient of the adaptive filter 62 is completed, the echo canceller 6 can sufficiently remove a sidetone and an echo. Accordingly, the removal error signal e enters not more than a predetermined level. When the removal error signal e enters not more than the predetermined level, the voice detector 65 stops the transmission of the inhibition signal p to the voice speed converting unit 5. Accordingly, the voice speed converting unit 5 starts voice speed conversion processing, and outputs the voice signal which has been subjected to voice speed conversion processing to the D/A converter 8 in the succeeding stage. As a result, the telephone receiving signal is subjected to voice speed conversion processing at a predetermined speed, and is outputted from the loudspeaker 2.

According to the third embodiment, the echo canceller 6 can stop the operation of the voice speed converting unit 5 while it is learning the echo path in order to optimize the filter coefficient of the adaptive filter 62 and can output the voice signal without subjecting the voice signal to voice speed conversion processing. Accordingly, it is possible to prevent the sidetone and the echo which cannot be removed during the learning in the echo canceller 6 from being subjected to voice speed conversion in the voice speed converting unit 5 and outputted therefrom.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A speech communication apparatus comprising:
a voice input device for inputting the voice of a calling party;
a voice output device for outputting the voice of a called party;
signal input/output means for introducing a voice signal of the calling party which has been outputted from the voice input device to a telephone line as well as receiving a voice signal of the called party which arrives through the telephone line;
voice speed conversion means provided between the voice output device and the signal input/output means for changing the time scale of the voice signal of the called party which arrives through the telephone line and the signal input/output means; and
sidetone erasure means provided between the voice speed conversion means and the signal input/output means for erasing a sidetone signal.

2. A speech communication apparatus comprising:
a voice input device for inputting the voice of a calling party;
a voice output device for outputting the voice of a called party;
signal input/output means for introducing a voice signal of the calling party which has been outputted from the voice input device to a telephone line as well as receiving a voice signal of the called party which arrives through the telephone line;
voice speed conversion means provided between the voice output device and the signal input/output means for changing the time scale of the voice signal of the called party which arrives through the telephone line;
sidetone erasure means provided between the voice speed conversion means and said signal input/output means for erasing a sidetone signal; and
means for mixing the voice signal of the calling party which has been outputted from the voice input device with a signal outputted by the voice speed conversion means and introducing a mixture of the signals to the voice output device.

3. The speech communication apparatus according to claim 1, wherein
the sidetone erasure means comprises
means for referring to the voice signal of the calling party which has been outputted from the voice input device to generate a pseudo sidetone signal, and
means for erasing, from a mixture of the voice signal of the called party which arrives through the telephone line and a sidetone signal, the sidetone signal using the pseudo sidetone signal.

4. The speech communication apparatus according to claim 2, wherein
the sidetone erasure means comprises
means for referring to the voice signal of the calling party which has been outputted from the voice input device to generate a pseudo sidetone signal, and
means for erasing, from a mixture of the voice signal of the called party which arrives through the telephone line and a sidetone signal, the sidetone signal using the pseudo sidetone signal.

5. The speech communication apparatus according to claim 1, wherein
the voice speed conversion means changes the time scale of the voice signal of the called party which is inputted through the sidetone erasure means.

6. The speech communication apparatus according to claim 2, wherein
the voice speed conversion means changes the time scale of the voice signal of the called party which is inputted through the sidetone erasure means.

7. The speech communication apparatus according to claim 1, wherein
the voice speed conversion means expands the time scale of the voice signal of the called party which is inputted through the sidetone erasure means.

8. The speech communication apparatus according to claim 2, wherein
the voice speed conversion means expands the time scale of the voice signal of the called party which is inputted through the sidetone erasure means.

9. In a speech communication apparatus comprising an echo canceller for learning an echo path and optimizing a filter coefficient of an adaptive filter to remove an echo signal and output a telephone receiving signal, and voice speed conversion means for subjecting the telephone receiving signal outputted by the echo canceller to voice speed conversion, the speech communication apparatus wherein
a voice speed converting operation by the voice speed conversion means is stopped during a predetermined time period.

10. In a speech communication apparatus comprising an echo canceller receiving a telephone transmitting signal as a reference input signal, generating a pseudo echo signal on the basis of the reference input signal, removing an echo signal which arrives by the pseudo echo signal, and outputting a telephone receiving signal, and voice speed conversion means for subjecting the telephone receiving signal inputted through the echo canceller to voice speed conversion and outputting the telephone receiving signal which has been subjected to voice speed conversion, the speech communication apparatus wherein
a voice speed converting operation by the voice speed conversion means is stopped during a predetermined time period.

11. The speech communication apparatus according to claim 9, wherein
the predetermined time period is a time period during which an echo path is learned in the echo canceller.

12. The speech communication apparatus according to claim 10, wherein
the predetermined time period is a time period during which an echo path is learned in the echo canceller.

13. The speech communication apparatus according to claim 9, wherein
the predetermined time period is an initial time period during which speech communication is started.

14. The speech communication apparatus according to claim 10, wherein
the predetermined time period is an initial time period during which speech communication is started.

15. In a speech communication apparatus comprising an echo canceller for learning an echo path and optimizing a filter coefficient of an adaptive filter to remove an echo signal and output a telephone receiving signal, and voice speed conversion means for subjecting the telephone receiving signal outputted by the echo canceller to voice speed conversion, the speech communication apparatus comprising:
means for judging whether or not the echo signal which cannot be removed by the echo canceller (a removal error signal) is at not less than a predetermined level; and
means for stopping a voice speed converting operation by the voice speed conversion means when the echo signal which cannot be removed by the echo canceller (the removal error signal) is at not less than the predetermined level.

16. In a speech communication apparatus comprising an echo canceller receiving a telephone transmitting signal as a reference input signal, generating a pseudo echo signal on the basis of the reference input signal, removing an echo signal which arrives by the pseudo echo signal, and outputting a telephone receiving signal, and voice speed conversion means for subjecting the telephone receiving signal inputted through the echo canceller to voice speed conversion and outputting the telephone receiving signal which has been subjected to voice speed conversion, the speech communication apparatus comprising:
means for judging whether or not the echo signal which cannot be removed by the echo canceller (a removal error signal) is at not less than a predetermined level; and
means for stopping a voice speed converting operation by the voice speed conversion means when the echo signal which cannot be removed by the echo canceller (the removal error signal) is at not less than the predetermined level.
